(19) United States
(12) Patent Application Publication
(10) Pub. No.: US 2004/0255699 A1
(43) Pub. Date: Dec. 23, 2004

(54) Optical displacement torque sensor

(76) Inventors: Robert J. Matzoll, Deltona, FL (US); Thomas T. Stapleton, Rochester, MI (US)

Correspondence Address: WILLIAM M HANLON, JR, YOUNG & BASILE, PC, 3001 WEST BIG BEAVER ROAD, SUITE 624, TROY, MI, 48084-3107, US

(21) Appl. No.: 10/867,005

(22) Filed: Jun. 14, 2004

Related U.S. Application Data
(60) Provisional application No. 60/478,120, filed on Jun. 12, 2003.

(51) Int. Cl. G01L 3/02

(52) U.S. Cl. 73/862.324

(57) ABSTRACT

An apparatus and method for noncontact, optical measuring of any of torque, torque angle, shaft speed, and shaft direction by at least one of a rotatable and compressible flexure with input and output ends plus input and output couplers, a light source for generating a light signal, a field mask formed of a pattern of opaque and transparent lines adapted to receive the light signal and generate a phase shifted light signal, and detector means for receiving a light signal from overlaid lines on the flexure and the field mask. Alternatively, the detector means may receive the light signal from overlaid lines on the input and output couplers of the flexure and the field mask and generate an output signal indicative of the combined pattern of the lines.

### CROSS REFERENCE TO RELATED APPLICATIONS

This application claims the benefit of the Jun. 12, 2003 filing date of U.S. Provisional Application No. 60/478,120, the entire contents of which are hereby incorporated by reference.

### BACKGROUND

The present invention relates to torque sensors, specifically to torque sensors using non-contact optics for the measurement of torque, torque angle, flexure speed, flexure direction and flexure rotational travel.

A conventional method and device for measuring torque generally requires physical contact with the torque sensor's center shaft. Applying torque to a shaft generates two principal lines of stress along helical lines which are orthogonal to each other on the surface of the shaft. Strain gauges are bonded in a cross arrangement along the helical lines. The strain gauges are coupled to measuring electronics by slip rings. However, these arrangements are difficult to implement.

Non-contact, optical based torque sensors are also known. Such sensors make use of a flexure or shaft, typically formed of metal. One end of the shaft is connected to a driving member, such as a motor, and the other end is connected to a tool or bit which drives a fastener, such as a bolt, to a tightened state, for example. Increased torque on the output end of the shaft as the bolt tightens causes rotation of the output end to lag behind rotation of the driven input end of the shaft. This lag can be used as an indicator of the amount of rotation of the output end which is proportional to the applied torque.

An example of an optically based torsion sensor is described by Bechtel, U.S. Pat. No. 5,001,937. Bechtel discloses a device for measuring torsion in a rotating shaft. The Bechtel device requires usage of a band consisting of alternating high and low reflectivity regions. The band is stationed on the shaft at the desired location of measurement. One sensor head is located to correspond to each band. Light is projected onto the respective band by the corresponding sensor. Furthermore, each sensor collects the light reflected by the high reflectivity region(s) of the corresponding band. The phase displacement between the intensities of the reflected light at the sensor heads is used to determine torsion on the rotating shaft.

However, it would be desirable to provide a torque sensor with non-contact optics to make implementation a lot simpler than conventional torque measurement methods and devices. It would also be desirable to provide a dynamic torque sensor that is not just limited to the measurement of torque, but is also capable of measuring torque angle, flexure speed, and flexure direction of travel.

### SUMMARY OF THE INVENTION

The present invention is an apparatus for the measurement of any of the torque, torque angle, flexure speed, flexure direction, and flexure rotational travel. The apparatus includes a non-contact rotary optical displacement sensor, and a rotatable and compressible flexure with input and output ends. The non-contact rotary optical displacement sensor also includes a light source for generating a light signal, a field mask adapted to receive the light signal and generate a phase shifted light signal. The flexure may contain a pattern of reflective and non-reflective lines associated with input and output ends. Alternatively, patterns of reflective and non-reflective lines may be on the input and output shaft of the flexure or projected onto the input and output shafts.

The sensor also includes detector means for receiving a light signal. The detector means receives the phase shifted light signal of the overlaid lines associated with the flexure and the field mask or the overlaid lines on the input and output end of the flexure and the field mask and generates an output signal indicative of the combined pattern of the lines.

The flexure of the apparatus can include the reflective and non-reflective lines being equi-circumferentially spaced about the input and output ends of the flexure.

The field mask of the apparatus is mounted about a circumference of the flexure. Furthermore, the field mask is fixed and stationarily supported relative to the flexure by mounting means. The mounting means includes, in one aspect, an arm securely fixed to an angle bracket that is fixed to a housing surrounding the flexure. Alternatively, the field mask may be mounted about a circumference of the input and output shaft of the flexure.

The field mask opaque and transparent lines of the apparatus share the same size and direction.

The field mask opaque and transparent lines and the flexure input and output lines form a Moire pattern for reflective and non-reflective lines. Alternatively, the field mask opaque and transparent lines and the input and output end coupler lines form a Moire pattern for reflective and non-reflective lines.

The light signal received by the detector in the apparatus is digitized and transmitted to a signal processor for analysis.

The present invention also defines a method of optically measuring one of torque, torque angle, shaft speed, and shaft direction comprising the steps of providing a flexure element, coupling an input end of the flexure to a torque transmitting mechanism that will displace the flexure in proportion to the torque transmitted by an output end of the flexure to a rotatable element engaged by the flexure and measuring the displacement of one end of the flexure relative to the other end to yield a measurement of torque.

The present invention has been designed to simplify the complex audit method required for critical joints with high installation torque and frictional scatter. The sensor has been designed to provide a torque sensor with non-contact optics to make implementation simpler than conventional torque measurement methods and devices. Furthermore, the present invention provides a dynamic torque sensor that is not limited to the measurement of torque as conventional torque measurement devices because the invention is also capable of measuring torque angle, flexure speed, and flexure direction of travel.

### BRIEF DESCRIPTION OF THE DRAWING

The description herein makes reference to the accompanying drawing wherein like reference numerals refer to like parts throughout the several views, and wherein:

FIG. 1 is a front elevational view of an optical displacement torque sensor according to the present invention;

FIG. 2 is a pictorial representation of the sensor of FIG. 1 coupled to control circuitry;

FIG. 3 is waveform of the output of the sensor shown in FIG. 1;

FIG. 4 is a perspective of the flexure of the present invention;

FIGS. 5A and 5B are end and plan elevational views showing the reflected light paths between the light emitters and light detectors of the sensor shown in FIG. 2;

FIG. 6A is a pictorial side-by-side representation of gradient lines on the flexure and field mask;

FIG. 6B is a pictorial representation of the gradient lines prior to loading;

FIG. 6C is a pictorial representation, similar to FIG. 6B, but showing the gradient lines resulting from torsional lag in the lines on the output end of the flexure;

FIG. 7 is a waveform diagram depicting the lag between the input end and output end sensors of the present invention; and

FIG. 8 is an end view showing the mounting of the field mask over the flexure shown in FIG. 2.

FIG. 9 is a side view of an input coupler of the present invention possessing reflective and non-reflective lines.

FIG. 9A is a perspective view of the input coupler of FIG. 9 possessing an internal mating spline fitting for a splined flexure.

FIG. 10 is a perspective view of the splined flexure.

FIG. 10A is a perspective view of the splined flexure inserted into the internal mating spline fitting of the input coupler of FIG. 9.

### DETAILED DESCRIPTION

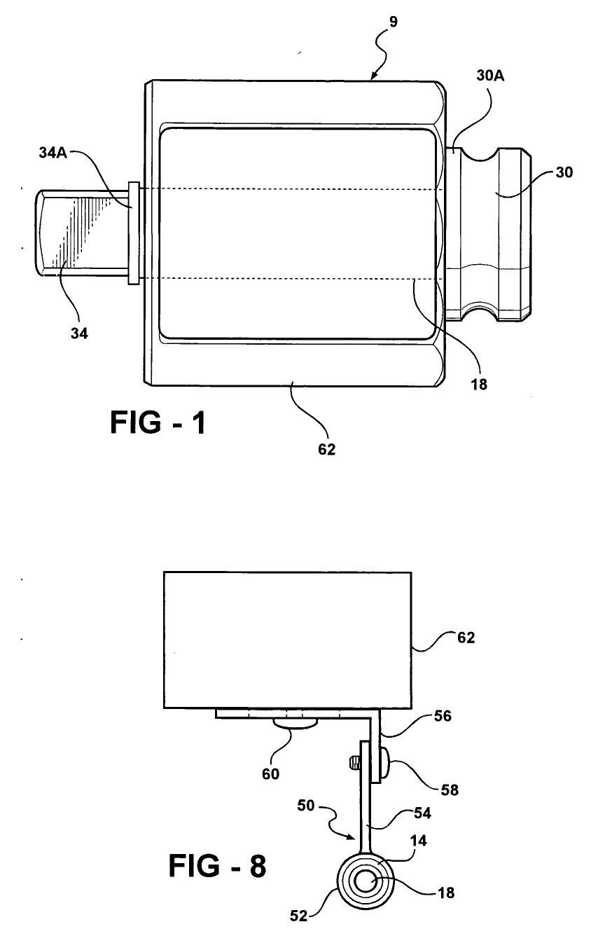

With reference now to the drawings, the preferred aspects of the invention are illustrated only by example and not for purposes of limiting same. FIGS. 1 and 2 show a rotary optical displacement sensor apparatus 9 which is particularly useful in measuring torque being transmitted to a rotatable element, such as a fastener. The apparatus 9 includes an element, called a flexure 18 with an input end 30A and an output end 34A, in line with the torque transmitting mechanism, that will displace to a degree that is proportional to the torque transmitted to the fastener. The displacement is then measured to yield a measurement of torque. The non-contact optical method of measurement described herein measures the amount of flexure displacement, flexure speed, and/or flexure direction and flexure rotational travel.

Displacement can occur by twist or compression of the flexure 18 relative to the rotation of an input and output coupler 30 and 34, respectively, attached to the input and output end 30A and 34A, respectively, of the flexure 18.

Although the flexure 18 could be formed of a metal, such as steel, according to one aspect of the present invention, the flexure 18 is formed of a displaceable polymer, such as urethane, elastomer, synthetic rubber, etc. A urethane formed flexure 18 will have sufficient rigidity so that an output end 34A will repeatedly displace the same amount under the same applied torque or force over a wide load and temperature range. Further, forming the flexure 18 of a polymer, such as urethane for example only, provides the flexure 18 with a greater amount of flex or displace at lower torque, which facilitates accurate measurement of low torque devices, such as power screwdrivers.

A pattern of fine parallel lines 28 and 32, alternatively reflective and non-reflective, are applied to the ends of the flexure 18 as shown in FIGS. 2 and 4. Alternatively, reflective and non-reflective lines 28 and 32 may be applied onto or projected onto an input and output couplers 30 and 34, respectively, as shown in FIG. 9, to which the flexure 18 is firmly attached. When the lines 28 and 32 are applied to the ends of the flexure 18, the lines 28 and 32 may be parallel to the longitudinal axis of the flexure 18 when the flexure 18 is not subjected to external forces.

When the reflective and non-reflective lines 28 and 32, as shown in FIGS. 9 and 9A, are applied onto or projected onto the input coupler 30 and output coupler 34, a splined flexure 18A is used, as shown in FIGS. 10 and 10A. FIG. 10A depicts the splined flexure 18A inserted into the input coupling 30 spline fitting 30B. The input coupler 30 and output coupler 34 possess internal mating spline fittings 30B, as shown in FIG. 10A, corresponding to the splined flexure 18A to hold and drive the flexure 18A. As shown in FIG. 9A, the bearing 66 mounted coupler 30 includes a silver ring 64. The ring 64 is centered by use of an o-ring 68 pressed around the spline fitting 30B that is welded to the backside of the coupling 30.

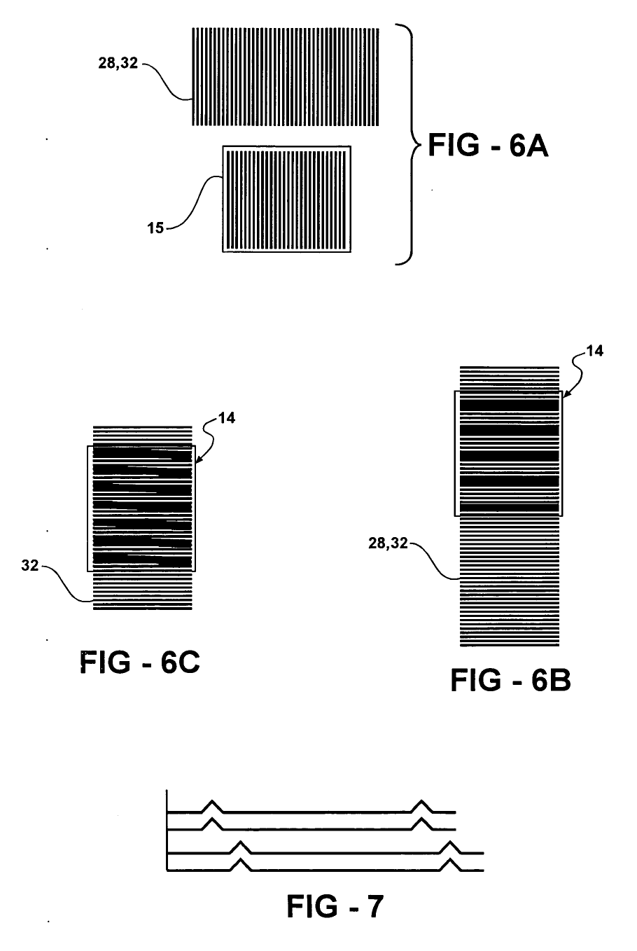

When the reflective and non-reflective lines 28 and 32, shown in FIGS. 6A, 6B and 6C, are applied to the flexure 18, the lines 28 and 32 may be applied to the ends of the flexure 18 by any suitable means, including printing, photoetching, etc. The lines 28, 32 are preferably equi-circumferentially spaced about the ends of the flexure 18. The lines 28, 32 may be formed partially or completely around the circumference of the flexure 18 or couplers 30 and 34.

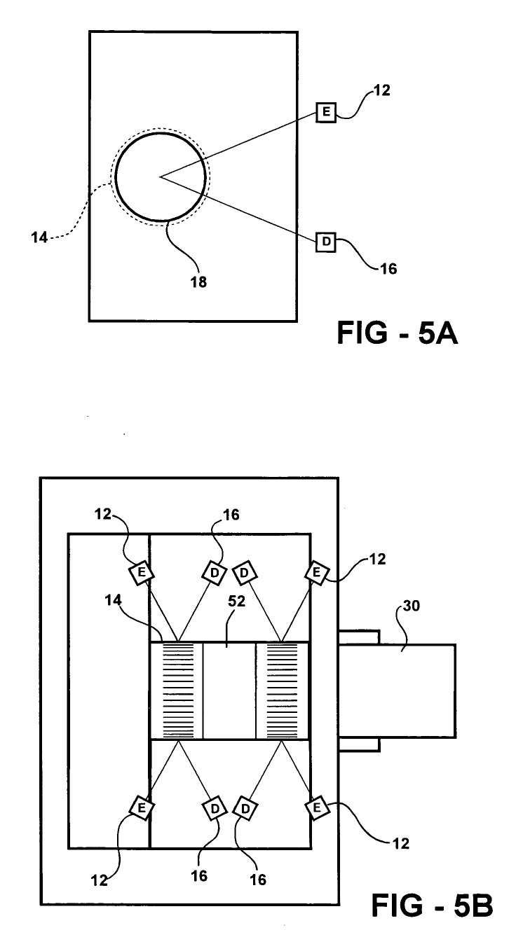

As the flexure 18 displaces due to the torque applied to one end, such as the input end 30A, the lines 32 on the output end 34A become displaced relative to the lines 28 on the input end 30A. Optical systems 9 at each end of the flexure 18, consisting of a light source 12, a field mask 14 and a silicon diode detector 16, measure this displacement as shown in FIGS. 2, 5A and 5B.

Although two pairs of light sources 12 and detectors 16 are employed at each end of the flexure 18, it will be understood that this is by way of example only, as an optical sensor 9 according to the present invention may have a single light source/detector at each input 30A and output end 34A.

The light source 12 may be any suitable light source. Although a laser can be employed as the light source 12, according to one aspect of the present invention, the light source 12 may be formed of an inexpensive LED.

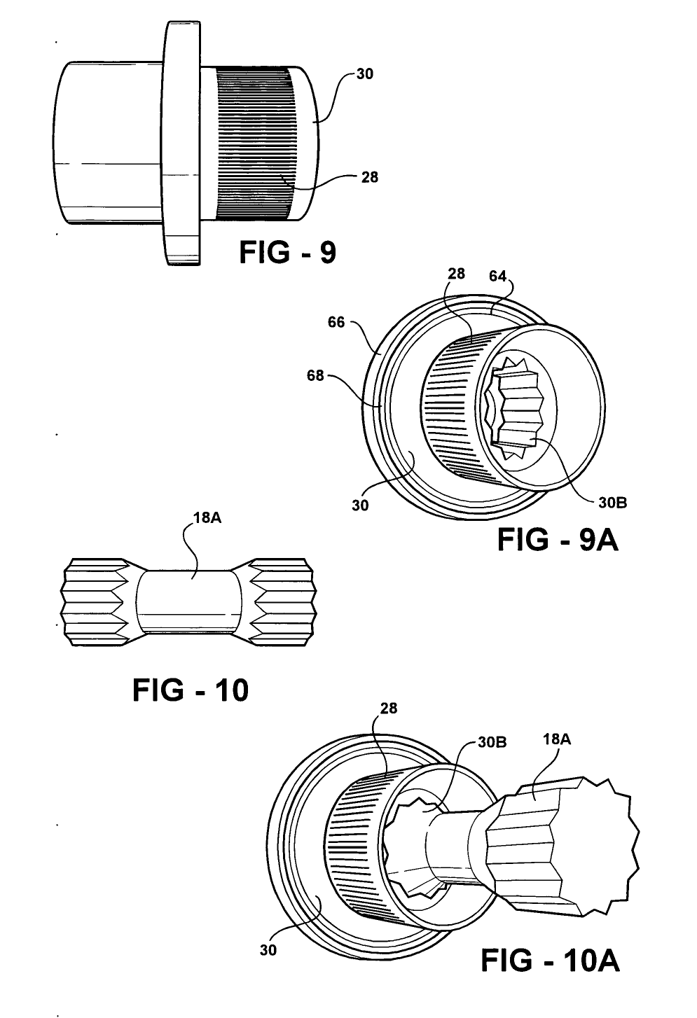

The field mask 14 is formed of a thin, transparent material, such as a plastic film, which is mounted a slight distance about the circumference of the flexure 18, preferably over each series of lines 28 and 32. The mask 14 is fixedly and stationarily supported relative to the rotating flexure 18 by means of a mount 50, as shown in FIG. 8. The mount 50 includes a support 52 in the form of a ring mounted intermediate to the ends of an elongated, cylindrically shaped sleeve used to form and carry the field masks 14 for each end of the flexure 18. Grating or gradient lines 15 as shown in FIG. 2 are formed, as described hereafter, on each end of the sleeve. Alternatively, the field mask 14 may be mounted a slight distance about the circumference of the input 30 and output couplers 34 when the reflective and non-reflective lines 28 and 32 are applied onto or projected onto the input 30 and output couplers 34.

As shown in FIG. 8, the field mask 14 is fixed a short distance away from the outer surface of the flexure 18 by the mount 50 which, by example only, includes an arm 54 connected to the ring 52. The arm 54 is secured to an angle bracket 56 by suitable attachment means, such as a fastener 58. The angle bracket 56 is in turn fixed by a fastener 60 to a housing 62 surrounding the flexure 18.

As shown in FIG. 2, the field mask 14 includes a pattern of transparent and opaque lines 15 that are identical in size and direction and may be substantially identical in spacing to the patterns of the lines 28 and 32 on the ends of the flexure 18. Alternately, the lines 15 on the field mask 14 may also have a different spacing than the spacing of corresponding lines 28 and 32 on the flexure 18. The lines 15 may be printed, etched or otherwise formed on the film at the appropriate positions by suitable means.

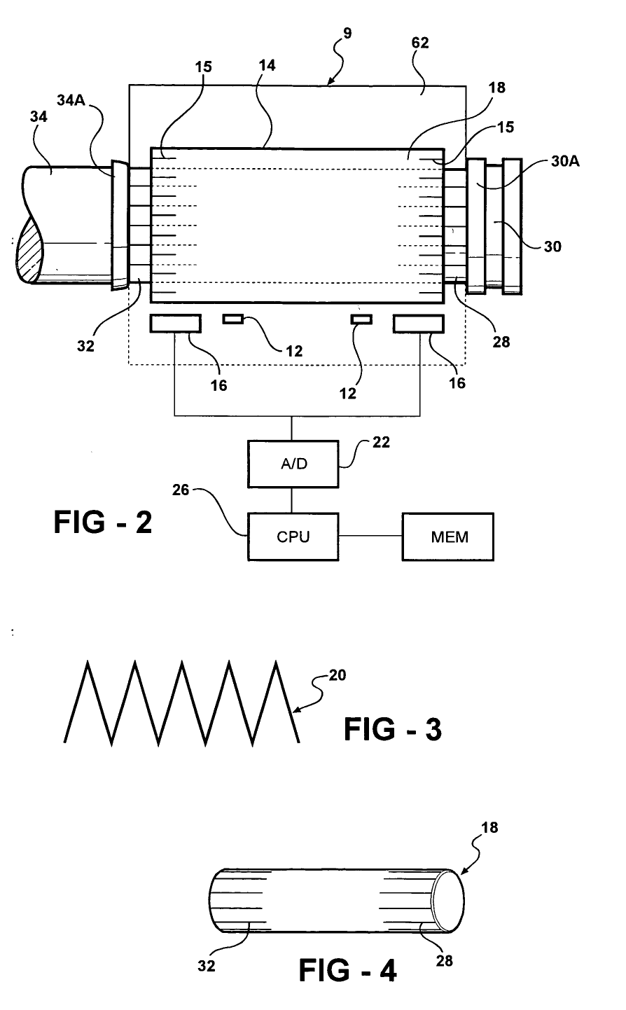

Light from the light source 12 passes through the mask 14 and is reflected by the pattern of lines 28, 32 on the rotating flexure 18. The result of the interaction between the pattern of lines 28 and 32 on the flexure 18 and the pattern of lines 15 on the field mask 14, as the flexure 18 rotates, is a periodic variation in light flux passing through the field mask 14 as the reflective lines 28, 32 on the flexure 18 align and misalign with lines 15 on the field mask 14 as seen in FIGS. 6B and 6C. The signal produced in FIG. 3 by the detector 16 will be an analog triangular wave 20 whose frequency is equal to the frequency of the lines 28 or 32 on the rotating flexure 18 as they pass under the field mask 14.

The lines 15 on the mask 14 and the lines 28, 32 on the flexure 18 are arranged so as to form Moire patterns which are reflective and non-reflective regions that result when two identical, repetitive patterns of lines, circles, or arrays of dots are overlapped with imperfect alignment.

It will be understood that the Moire patterns are not produced in the mask 14 or the flexure 18, but rather are a pattern of an image viewable by the human eye. In some places, opaque lines 15 on the mask 14 hide the reflective lines or spaces between the non-reflective lines 28, 32 on the flexure 18, creating a non-reflective viewable region. When the opaque lines 15 on the mask 14 align with the non-reflective lines 28, 32 on the flexure 18, the neighboring reflective areas between the non-reflective lines 15 and 28, 32 show through. The patterns formed by the regions of reflective and non-reflective lines compose the Moire patterns which are imaged by the internal optics of the sensor 16.

As torque builds up, the lines 32 at the output end 34A of the flexure 18 lag more and more behind the lines 28 at the input end 30A in proportion to the torque, due to the displacement in the flexure 18. During such displacement, the relative position of the imaged Moire pattern will change as the output end 34A of the sensor 9 connected to the rotating fastener head lags behind the input end 30A of the flexure 18 connected to the rotating power tool or drive source. Correspondingly, the triangular wave signal 20 from the output end 34A detector 16 lags behind the triangular wave signal 20 from the input end 30A detector 16 signal. These signals 20 can be digitized via an analog to digital converter 22 which samples the waveforms shown in FIG. 7. The digital signal representation can then enter into a signal processor, such as a computer 26, shown in FIG. 2, for analysis.

Determination of the degree of rotational lag by comparing the signals from the output end 34A of the flexure 18 to the input end 30A of the flexure 18 is straightforward, but must take into account the varying speed of the rotating flexure 18. The triangular waves 20 shown in FIG. 3 will change frequency, possibly rather abruptly, as the flexure 18 slows near the target torque value.

At some degree of torque, the displacement of the flexure 18 will equal the width of a line pair (combined reflective and non-reflective lines). At this point, the input and output detector waveforms will again be in phase, as they were with no torque applied.

To avoid ambiguity, the control program executed in the signal analysis device 26 shown in FIG. 2, must keep track of the number of complete cycles, line by line, of the 360° shift the waveforms 20 shown in FIG. 3, have gone through. The complete torque measurement will be a function of this number plus the fractional shift measured via the detector 16 shown in FIGS. 2 and 5A of the rotary optical displacement sensor 9 by the phase difference between the two signals.

The rotational velocity of both the input end 30A and the output end 34A of the flexure 18 can be measured by measuring the frequency of the signals (peak to peak) generated by the detectors 16 at the input end 30A and the output end 34A of the flexure 18, respectively.

The direction of rotation of the flexure 18 can be determined by providing two detection systems 16 at each end of the flexure 18 and comparing the signals generated by the two detection systems 16. These detectors 16 are positioned relative to one another, as shown in FIG. 5A, such that the signals generated by them are 90° out of phase with each other. Arbitrarily designating the two signals as A and B, rotation in one direction will produce signals where A leads B by 90°, see FIG. 7, whereas rotation in the opposite direction will produce signals where B leads A by 90°. Direction of rotation is thus determined by the relative phase between the two signals.

Torque angle is the angle through which the fastener is turned past the point at which a threshold torque is reached and until the target torque is reached. The sequence of events culminating in this measurement are as follows: Before the fastener begins to tighten, little torque is generated and the input end 30A and the output end 34A of the flexure 18 rotate at a common velocity and with little displacement in the flexure 18, as shown in FIG. 2. As the fastener begins to tighten, the torque begins to increase and reaches a threshold value. This results in an increase in the displacement of the flexure 18 that is detected and quantitatively measured by analysis of the input 30A and output end 34A detector 16 signals. Detection of the threshold torque initiates the measurement of angular rotation at the output end 34A of the flexure 18, as shown in FIG. 2. This measurement continues until the target torque is detected. At this point, the measurement of torque angle is complete and its value is stored in a memory for later display, printout or archiving.

Final torque, which could be larger than target torque if the fastener driving mechanism is not properly controlled, can be measured by recording the measured torque at the point that the output end 34A of the flexure 18 comes to a stop. As the output end 34A of the flexure 18 slows to a near stop, the signals generated by the detectors 16 change very slowly. It is necessary to distinguish between a slow change and no change. For an accurate measure of final torque, it may preferred that the detector 16 signals be stored in a computer memory and subsequently analyzed to accurately determine the point in time that the output end 34A of the flexure 18 came to a stop.

What is claimed is:

1. A method of optically measuring one of torque, torque angle, shaft speed and shaft direction, the method comprising the steps of:
providing a flexure element;
coupling an input end of the flexure to a torque transmitting mechanism that will displace the flexure in proportion to the torque transmitted by an output end of the flexure to a rotatable element engaged by the flexure; and
measuring the rotational lag of one end of the flexure relative to the other end to yield a measurement of torque.

2. The method of claim 1 further comprising the step of:
measuring flexure directional rotation by providing detection means at each end of the flexure and comparing the signals generated by the detection means.

3. The method of claim 1 further comprising the step of:
measuring torque angle by recording the point at which a threshold torque is reached and then measuring the angular motion of the output end of the flexure until a target torque is reached.

4. The method of claim 1 further comprising the step of:
measuring rotational speed of the flexure by measuring the frequency of the transmitted signals generated by detection means at one of the input and output ends of the flexure.

5. A non-contact rotary optical displacement sensor apparatus for use in conjunction with a torque transmitting mechanism, the non-contact rotary optical displacement sensor comprising:
at least one of a rotatable and compressible flexure with input and output ends;
means for providing a pattern of reflective and non-reflective lines on at least one of the flexure and an input and output coupler attached to the flexure;
a light source for generating light to the flexure;
a field mask composed of a pattern of opaque and transparent lines adapted to receive the light from the light source transmitted through the mask that is reflected by the reflective and non-reflective line patterns and, after receiving the light the mask generates a phase shifted light signal; and
detector means for receiving the phase shifted light signal.

6. The non-contact rotary optical displacement sensor of claim 5 wherein the pattern of reflective and non-reflective lines are disposed on the input and output ends of the flexure.

7. The non-contact rotary optical displacement sensor of claim 5 wherein the pattern of reflective and non-reflective lines are at least one of applied on and projected on the input and output coupler.

8. The non-contact rotary optical displacement sensor of claim 7 wherein the input and output coupler mate with a splined flexure.

9. The non-contact rotary optical displacement sensor of claim 5 wherein the field mask generates the phase shifted light signal based on the reflected pattern of lines on at least one of the rotating flexure and the input and output couplers.

10. The non-contact rotary optical displacement sensor of claim 5 wherein the detection means receives the phase shifted light signal from one of overlaid lines on the flexure and the field mask and overlaid lines from the input and output coupler and the field mask and generates an output signal indicative of the combined pattern of the lines.

11. The non-contact rotary optical displacement sensor of claim 6 wherein the reflective and nonreflective lines are equi-circumferentially spaced about the input and output ends of the flexure.

12. The non-contact rotary optical displacement sensor of claim 5 wherein the field mask is formed of a transparent material.

13. The non-contact rotary optical displacement sensor of claim 12 wherein the field mask is mounted about at least one of a circumference of the flexure and a circumference of the input and output couplers.

14. The non-contact rotary optical displacement sensor of claim 13 wherein the field mask is fixedly and stationarily supported relative to the flexure by means of a mount.

15. The non-contact rotary optical displacement sensor of claim 14 wherein the mount includes a support.

16. The non-contact rotary optical displacement sensor of claim 15 wherein the support is formed in the shape of a ring mounted intermediate to the ends of a sleeve forming and carrying the field mask.

17. The non-contact rotary optical displacement sensor of claim 16 wherein grating lines are formed on each end of the sleeve.

18. The non-contact rotary optical displacement sensor of claim 15 wherein the mount includes an arm connected to a ring.

19. The non-contact rotary optical displacement sensor of claim 18 wherein the arm is securedly fixed to an angle bracket by attachment means.

20. The non-contact rotary optical displacement sensor of claim 19 wherein the angle bracket is affixed to a housing surrounding the flexure.

21. The non-contact rotary optical displacement sensor of claim 5 wherein the field mask opaque and transparent lines have the same size and orientation.

22. The non-contact rotary optical displacement sensor of claim 21 wherein the opaque and transparent lines are substantially identical in spacing to input lines and output lines on the flexure.

23. The non-contact rotary optical displacement sensor of claim 5 wherein the field mask opaque and transparent lines have different spacing relative to the spacing of an input lines and output lines on the flexure.

24. The non-contact rotary optical displacement sensor of claim 23 wherein the field mask opaque and transparent lines and the flexure input and output lines form a Moire pattern of reflective and nonreflective lines.

25. The non-contact rotary optical displacement sensor of claim 5 wherein the light signal received by the detector means is digitized by an analog to digital converter.

26. The non-contact rotary optical displacement sensor of claim 25 wherein the digitized signal is transmitted to a signal processor for analysis.
